(19) United States
(12) Patent Application Publication
(10) Pub. No.: US 2007/0263670 A1
(43) Pub. Date: Nov. 15, 2007

(54) STATE SYNCHRONIZATION APPARATUSES AND METHODS

(75) Inventor: Chih Lin Hu, Tainan City (TW)

Correspondence Address: QUINTERO LAW OFFICE, PC, 2210 MAIN STREET, SUITE 200, SANTA MONICA, CA, 90405, US

(73) Assignee: BENG CORPORATION, TAOYUAN (TW)

(21) Appl. No.: 11/746,454

(22) Filed: May 9, 2007

(30) Foreign Application Priority Data
May 12, 2006 (TW) TW95116879

(51) Int. Cl. H04J 3/06

(52) U.S. Cl. 370/503

(57) ABSTRACT

A method for state synchronization, performed by a first electronic apparatus, comprises the following steps. A local cache of the first electronic apparatus stores a first service state value. It is determined whether the first service state value has expired before receiving a next event notification. A second service state value is acquired by issuing a request to a service resident on a second electronic apparatus when determining that the first service state value has expired. The second service state value is stored in the local cache. The first electronic apparatus continually connects to a network. The next event notification is utilized to carry the newest service state value.

### BACKGROUND

The invention relates to state synchronization, and more particularly, to state synchronization apparatuses and methods in a small-scale distributed service environment.

Devices in distributed environments may share common states for service coordination and collaboration, particularly in event-driven service management systems. In general, in service management systems, notifications of changes of service states may be processed in an asynchronous way: a service (or an administration console) sequentially notifies devices of all changed common states. The values of the common state are stored (or cached) in devices. The devices, however, maintain cached common states in different ways, and thus, may have inconsistent values of the common states, thereby causing failure of service coordination.

### SUMMARY

Methods for state synchronization, performed by a first electronic apparatus, are provided. An embodiment of a method for state synchronization comprises the following steps. A local cache of the first electronic apparatus stores a first service state value. It is determined whether the first service state value has expired before receiving a next event notification. A second service state value is acquired by issuing a request to a service resident on a second electronic apparatus when determining that the first service state value has expired. The second service state value is stored in the local cache. The first electronic apparatus continually connects to a network. The next event notification is utilized to carry the newest service state value.

An embodiment of a method for state synchronization comprises the following steps. The first electronic apparatus initially disconnects from a network. A local cache of the first electronic apparatus stores a first service state value. It is determined whether the first service state value has expired when reconnecting to the network. A second service state value is acquired by issuing a request to a service resident on a second electronic apparatus when determining that the first service state value has expired. The second service state value is stored in the local cache.

Apparatuses for state synchronization are provided. An embodiment of an apparatus for state synchronization comprises a local cache, a communication management module and a service state maintenance module. The local cache stores a first service state value. The service state maintenance module determines whether the first service state value has expired before receiving a next event notification, acquires a second service state value by issuing a request to a service resident on an electronic apparatus via the communication management module when determining that the first service state value has expired, and stores the second service state value in the local cache. The apparatus continually connects to a network. The next event notification carries the newest service state value.

An embodiment of an apparatus for state synchronization comprises a local cache, a communication management module and a service state maintenance module. The local cache stores a first service state value. The service state maintenance module determines whether the first service state value has expired when reconnecting to a network, acquires a second service state value by issuing a request to a service resident on a second electronic apparatus via the communication management module when determining that the first service state value has expired, and stores the second service state value in the local cache.

### BRIEF DESCRIPTION OF DRAWINGS

The invention will become more fully understood by referring to the following detailed description with reference to the accompanying drawings, wherein:

FIG. 1 is a diagram of network architecture of an embodiment of a state synchronization system;

FIG. 2 is a diagram of a hardware environment applicable to an embodiment of a personal computer;

FIG. 3 is a diagram of exemplary periodic notification of event notifications;

FIG. 4 is a flowchart of an embodiment of a state synchronization method executed by a personal computer;

FIG. 5 is a flowchart of an embodiment of a state synchronization method executed by a personal computer;

FIG. 6 is a diagram of a storage medium storing a computer program for state synchronization;

FIG. 7 is a module block diagram of an embodiment of a state synchronization apparatus;

FIG. 8 is a diagram of exemplary state synchronization.

### DETAILED DESCRIPTION

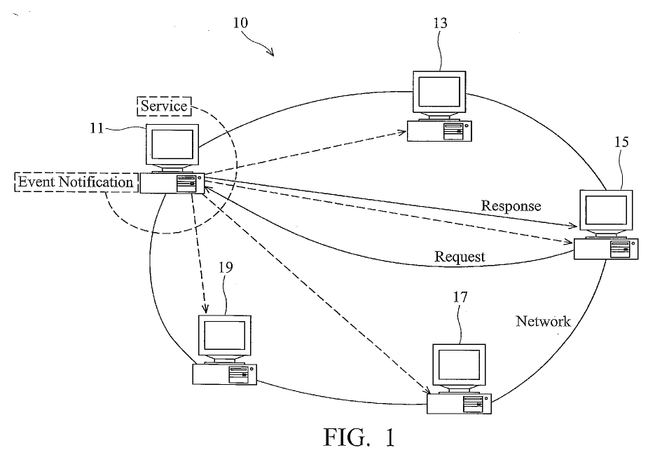

FIG. 1 is a diagram of network architecture of an embodiment of a state synchronization system 10, comprising personal computers 11, 13, 15, 17 and 19. The personal computers 11, 13, 15, 17 and 19 operate in a network using wired, wireless or a combination thereof to connect therebetween. Those skilled in the art will recognize that the personal computers 11, 13, 15, 17 and 19 may be connected in different types of networking environments, and may communicate therebetween through various types of transmission devices such as routers, gateways, access points, base station systems or others. The state synchronization system 10 employs a publisher-subscriber (or push) model to notify of state changes. Specifically, the personal computer 11 advertises services thereof in a network, enabling personal computers 13, 15, 17 and 19 to discover and to subscribe the advertised services. The personal computer 11 operates as a state source for transmitting event notifications respectively containing service state values to personal computers 13, 15, 17 and 19 in an asynchronous manner. The personal computers 13, 15, 17 and 19 may subscribe to the published service resident on the personal computer 11 (i.e. the publisher) in advance to later receive event notifications indicating state changes of the subscribed service. When multiple personal computers subscribe to the same service, the personal computer 11 may transmit event notifications to the subscribing personal computers by unicasting, multicasting or broadcasting, and subsequently, the subscribing personal computers store service state values in their local caches. In addition, the subscribing personal computers can request service state values and replace cached service state values with service state values in a corresponding response. Note that the personal computer 11 further transmits a valid duration corresponding to each service state value, where the corresponding service state value is valid until the valid duration expires.

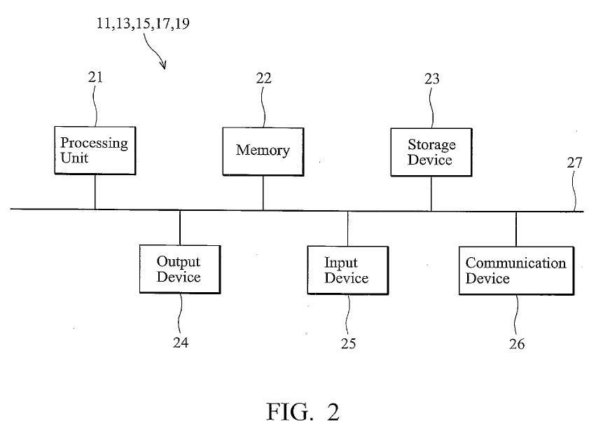

FIG. 2 is a diagram of a hardware environment applicable to an embodiment of the personal computers 11, 13, 15, 17 or 19, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 21, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform state synchronization functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. The programmable consumer electronics may be mobile stations, projectors, displays, mp3 players, personal digital assistants (PDAs), digital video recorders and the like. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

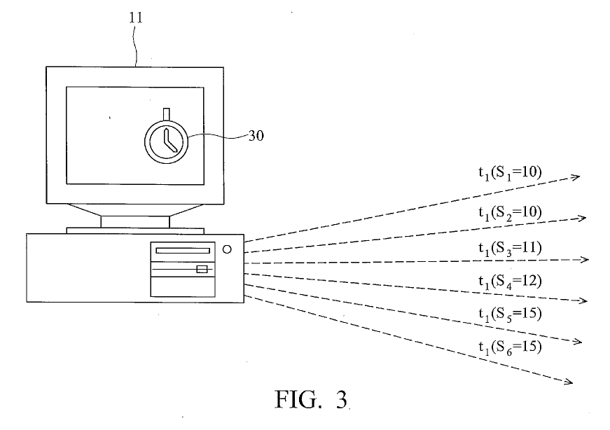

The personal computer 11 may transmit event notifications by instant notification or periodic notification. In instant notification, the personal computer 11 instantly transmits an event notification to all the subscribing personal computers when detecting that a service state of the subscribed service changes. FIG. 3 is a diagram of exemplary periodic notification of event notifications. In periodic notification, the personal computer 11 is equipped with a periodic notification timer 30 implemented in hardware circuits or programmable software. The personal computer 11 may set a notification period corresponding to the periodic notification timer 30, such as one or five seconds or one minute, or similar. The personal computer 11 transmits an event notification containing the current service state value to all the subscribed personal computers when detecting that the notification period is reached via the periodic notification timer 30. Note that, in periodic notification, a service state value contained in an event notification may be the same as a service state value contained in the next event notification.

Each event notification contains at least one event, and each event comprises a version identifier (ID), a service state value and a valid duration. Each event may be organized by the following format:
event:=“version ID”+“service state value”+“valid duration”.
   The version identifier differentiates an event (i.e. service state value) from others. The version ID may be represented in a form of a service ID hyphenated by an event ID, organized by the following format:
version ID:=“service ID”−“event ID”.
   Each service resident on the personal computer 11 has an identical service ID, and the event ID is an incremental integer. Note that, two different events published by the same service have the same service ID with different event Ids. These version IDs are checked when the subscribing personal computers operate for service coordination.

One personal computer 13, 15, 17 or 19 contains a timer, such as an absolute timer or a programmable timer. The absolute timer corresponds to a system timer whose value is increased by one every clock interval. The programmable timer is a programmable software timer whose value is decreased by one every time unit (e.g. a second or millisecond). When a personal computer containing an absolute timer receives an event notification, the personal computer stores a service state value, a version ID and a valid duration of the received event notification and further stores the current time value of the absolute timer. When a personal computer containing a programmable timer receives an event notification, the personal computer stores a service state value, a version ID and a valid duration of the received event notification and further initiates a time value counted by the programmable timer, where the initiated time value corresponds to the valid duration.

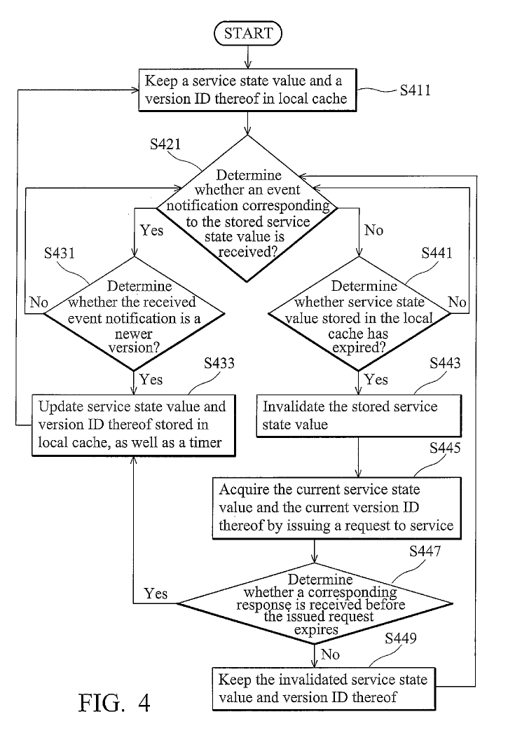

FIG. 4 is a flowchart of an embodiment of a state synchronization method executed by personal computer 13, 15, 17 or 19 continuously connecting to a network. In step S411, a service state value and a version ID thereof are kept (i.e. stored) in a local cache. The service state value and version ID thereof may be acquired from a received event notification or a response. The local cache may be implemented in the memory 22 or storage device 23 (FIG. 2). In step S421, it is determined whether an event notification corresponding to the stored service state value is received. If so, the process proceeds to step S431, otherwise, to step S441. In step S431, it is determined whether the received event notification is a newer version. If so, the process proceeds to step S433, otherwise, to step S421. Step S431 may be achieved by determining whether a version ID provided in the received event notification is newer than a version ID corresponding to the stored service state value. In step S433, the service state value and version ID thereof stored in the local cache are updated with the service state value and version ID thereof provided in the event notification. For an example of a personal computer containing an absolute timer, step S433 further updates a time value stored in the local cache with the current time value counted by the absolute timer, indicating an instant when updating the stored service state value and version ID thereof. For an example of a personal computer containing a programmable timer, step S433 further initiates a time value counted by the programmable timer.

In step S441, it is determined whether the service state value stored in the local cache has expired. If so, the process proceeds to step S443, otherwise, to step S421. For an example of a personal computer containing an absolute timer, step S441 determines whether the difference between the current time value counted by the absolute timer and the time value stored in the local cache exceeds or equals a value corresponding to a valid duration for the stored service state value, and, if so, step S441 determines that the stored service state value expires. For an example of a personal computer containing a programmable timer, step S441 determines whether the current time value counted by the programmable timer is equal to or lower than “0”, and, if so, step S441 determines that the stored service state value expires. In step S443, the stored service state value is invalidated. In step S445, the current service state value and the current version ID thereof are acquired by issuing a request to a service resident on the personal computer 11. In step S447, it is determined whether a corresponding response is received before the request expires. If so, the process proceeds to step S433, otherwise, to step S449. In step S433, the service state value and version ID thereof stored in the local cache are updated with the service state value and version ID thereof provided in the received response. In step S449, the invalidated service state value and version ID thereof are kept (i.e. stored) in a local cache.

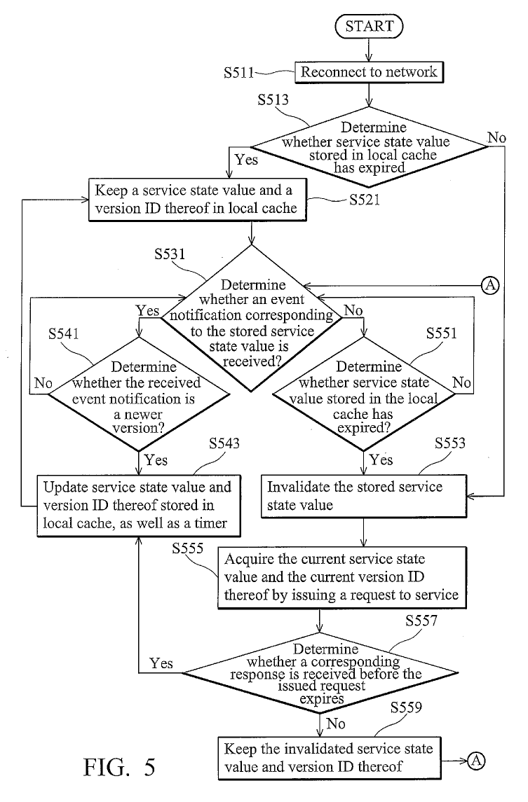

FIG. 5 is a flowchart of an embodiment of a state synchronization method executed by personal computer 13, 15, 17 or 19 reconnecting to a network, where personal computer 13, 15, 17 or 19 is initially disconnected. Steps S521 and S559 are similar to steps S411 to S449 (FIG. 4), and are only briefly described herein. Contrary to FIG. 4, this embodiment of the state synchronization method further comprises steps S511 and S513 performed at the beginning of reconnecting to a network. In step S511, a network is reconnected to. In step S513, it is determined whether a service state value stored in a local cache has expired. If so, the process proceeds to step S521, otherwise, to step S553. The details of the determination may refer to the description of step S431 (FIG. 4).

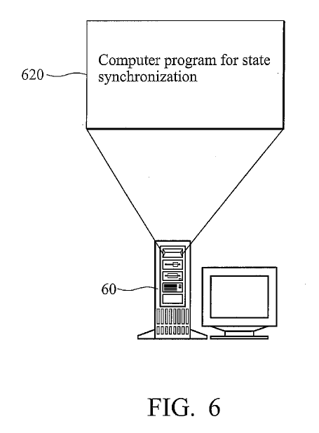

Also disclosed is a storage medium as shown in FIG. 6 storing a computer program 620 providing the disclosed state synchronization methods. The computer program includes a storage medium 60 having computer readable program code therein for use in a computer system. The computer readable program code, when loaded and executed by the processing unit 21 (FIG. 2), performs operations described in FIGS. 4 and 5.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

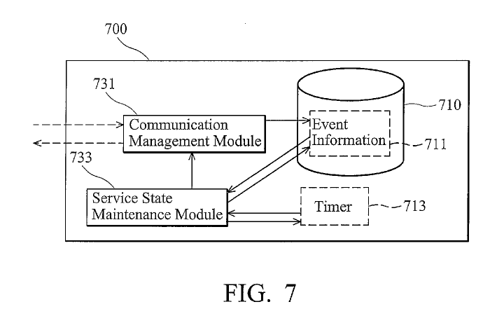

FIG. 7 is a module block diagram of an embodiment of a state synchronization apparatus 700 comprising a local cache 710, a timer 713, a communication management module 731 and a service state maintenance module 733. The state synchronization apparatus 700 may be a personal computer, such as personal computer 13, 15, 17 or 19. The local cache 710 stores event information 711 regarding the described event notifications, version IDs, service state values, valid durations and valid flags indicating whether service state values are valid. The timer 713 may be the described absolute timer or programmable timer. The service state maintenance module 733 performs all process steps as shown in FIGS. 4 and 5. Furthermore, referring to steps S421, S445, S447 (FIG. 4), S531, S555 and S559 (FIG. 5), the service state maintenance module 733 may transmit requests to the personal computer 11 (FIG. 1) and receive corresponding responses from the personal computer 11 via the communication management module 731.

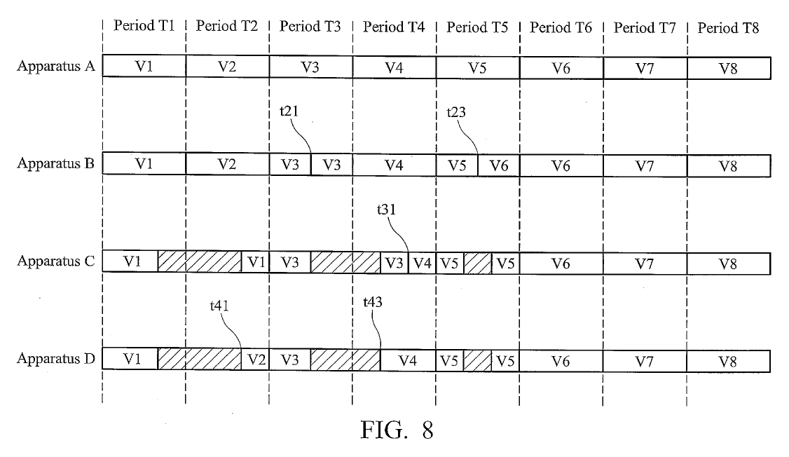

Detailed descriptions of state synchronization methods are provided in the following. FIG. 8 is a diagram of exemplary state synchronization. The personal computer 11 transmits event notifications to apparatuses A to D by the described instant notification at the beginning of period T7 and by the described periodic notification at the beginnings of periods T1 to T6 and T8 respectively. Event notifications respectively contain service state values and version IDs V1 to V8.

The apparatus A, being a passive apparatus, does not employ the described state synchronization methods to actively query the current service state value and version ID thereof. The apparatus A, continuously connecting to a network, passively receives event notifications from the personal computer 11, and accordingly updates a service state value and a version ID thereof stored in a local cache thereof.

The apparatuses B to D, being active apparatuses, employ the described state synchronization methods to actively query the current service state value and version ID thereof. The apparatus B continuously connects to a network and contains an absolute timer or a programmable timer. When detecting that a service state value stored in a local cache thereof expires (referring to step S441 of FIG. 4), at instants t21 and t23, the apparatus B queries (i.e. requests) the current service state value and version ID thereof from a service resident on the personal computer 11, and then, accordingly updates the service state value and version ID thereof (referring to steps S445, S447 and S443). It is to be understood that a response corresponding to a request issued at the instant t23 contains a newer version of service state value, thus, the apparatus B discovers changes of service state values earlier than the apparatus A.

Because apparatuses C and D are instable, they may disconnect from a network due to unexpected failures, the shadow areas represent disconnection periods. The apparatus C contains a programmable timer and the apparatus D contains an absolute timer. When reconnecting to a network (to thereby reconnect to the personal computer 11), the apparatuses C and D first determine whether service state values stored in local caches are valid (referring to steps S511 and S513 of FIG. 5), and then, acquires and updates the stored invalid service state values and version IDs thereof with the current service state values and version IDs thereof from the personal computer 11 if required. When the apparatus D disconnects from the network, the absolute timer thereof continuously counts. Thus, once reconnected to the network, such as at instants t41 and t43, the apparatus D instantly detects that the stored service state value expires, and acquires the current service state value and version ID from the personal computer 11. In contrast to the apparatus D, when the apparatus C disconnects from the network, the programmable timer thereof stops timing. Thus, once reconnected to the network, the apparatus C will not recognize that the stored service state value is valid, and as a result in prompt acquisition of the current service state value and version ID thereof is hindered.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for state synchronization, performed by a first electronic apparatus comprising a local cache storing a first service state value, comprising:
determining whether the first service state value expires before receiving a next event notification;
acquiring a second service state value by issuing a request to a service resident on a second electronic apparatus when determining that the first service state value expires; and
storing the second service state value in the local cache,
wherein the first electronic apparatus continually connects to a network and the next event notification is utilized to carry the newest service state value.

2. The method as claimed in claim 1 wherein the first electronic apparatus comprises a timer, the local cache stores a first valid duration corresponding to the first service state value, the determining step further determines whether the first service state value expires by referring to the timer and the first valid duration.

3. The method as claimed in claim 2 wherein the timer is an absolute timer whose value is increased by one every clock interval, the local cache of the first electronic apparatus stores a first time value indicating an instant when storing the first service state value, and the determining step determines that the first service state value expires when the difference between a second time value counted by the absolute timer and the first time value exceeds or equals a value corresponding to the valid duration.

4. The method as claimed in claim 2 wherein the timer is a programmable timer whose value is decreased by one every time unit, the value of the programmable timer is initiated to correspond to the first valid duration when storing the first service state value, and the determining step determines that the first service state value expires when the value of the programmable timer is equal to or lower than “0”.

5. The method as claimed in claim 1 further comprising:
invalidating the first service state value when receiving no corresponding response before the request expires.

6. The method as claimed in claim 1 further comprising:
determining whether a third service state value carried by the next event notification is newer than the first service state value when receiving the next event notification; and
updating the first service state value with the third service state value when the third service state value is newer than the first service state value.

7. The method as claimed in claim 1 wherein the local cache stores a first version identifier corresponding to the first service state value, the method further comprising:
determining whether a second version identifier corresponding to a third service state value carried by the next event notification is newer than the first version identifier when receiving the next event notification; and
updating the first service state value with the third service state value when the second version identifier is newer than the first version identifier.

8. A method for state synchronization, performed by a first electronic apparatus initially disconnected from a network, a local cache of the first electronic apparatus storing a first service state value, comprising:
determining whether the first service state value expires when reconnecting to the network;
acquiring a second service state value by issuing a request to a service resident on a second electronic apparatus upon determining that the first service state value has expired; and
storing the second service state value in the local cache.

9. The method as claimed in claim 8 wherein the first electronic apparatus comprises a timer, the local cache stores a first valid duration corresponding to the first service state value, the determining step further determines whether the first service state value has expired by referring to the timer and the first valid duration.

10. The method as claimed in claim 9 wherein the timer is an absolute timer whose value is increased by one every clock interval, the local cache of the first electronic apparatus stores a first time value indicating an instant when storing the first service state value, and the determining step determines that the first service state value has expired when the difference between a second time value counted by the absolute timer and the first time value exceeds or equals a value corresponding to the first valid duration.

11. The method as claimed in claim 9 wherein the timer is a programmable timer whose value is decreased by one every time unit, the value of the programmable timer is initiated to correspond to the first valid duration when storing the first service state value, and the determining step determines that the first service state value has expired when the value of the programmable timer is equal to or lower than “0”.

12. An apparatus for state synchronization, comprising:
a local cache storing a first service state value;
a communication management module; and
a service state maintenance module determining whether the first service state value has expired before receiving a next event notification, acquiring a second service state value by issuing a request to a service resident on an electronic apparatus via the communication management module upon determining that the first service state value has expired, and storing the second service state value in the local cache,
wherein the apparatus continually connects to a network and the next event notification is utilized to carry the newest service state value.

13. The apparatus as claimed in claim 11 further comprising a timer, wherein the local cache stores a first valid duration corresponding to the first service state value and the service state maintenance module determines whether the first service state value has expired by referring to the timer and the first valid duration.

14. The apparatus as claimed in claim 13 wherein the timer is an absolute timer whose value is increased by one every clock interval, the local cache stores a first time value indicating the instant when the first service state value is stored, and the service state maintenance module determines that the first service state value has expired when the difference between a second time value counted by the absolute timer and the first time value exceeds or equals a value corresponding to the valid duration.

15. The apparatus as claimed in claim 13 wherein the timer is a programmable timer whose value is decreased by one every time unit, the value of the programmable timer is initiated to correspond to the first valid duration when storing the first service state value, and the service state maintenance module determines that the first service state value has expired when the value of the programmable timer is equal to or lower than “0”.

16. The apparatus as claimed in claim 12 wherein the service state maintenance module invalidates the first service state value when receiving no corresponding response via the communication management module before the request has expired.

17. The apparatus as claimed in claim 12 wherein the service state maintenance module determines whether a third service state value carried by the next event notification is newer than the first service state value when receiving the next event notification, and updates the first service state value with the third service state value when the third service state value is newer than the first service state value.

18. The apparatus as claimed in claim 12 wherein the local cache stores a first version identifier corresponding to the first service state value, and the service state maintenance module determines whether a second version identifier corresponding to a third service state value carried by the next event notification is newer than the first version identifier when receiving the next event notification via the communication management module, and updates the first service state value with the third service state value when the second version identifier is newer than the first version identifier.

19. An apparatus for state synchronization, comprising:
a local cache storing a first service state value;
a communication management module; and
a service state maintenance module determining whether the first service state value has expired when reconnecting to a network, acquiring a second service state value by issuing a request to a service resident on a second electronic apparatus via the communication management module upon determining that the first service state value has expired, and storing the second service state value in the local cache.

20. The apparatus as claimed in claim 19 further comprising a timer, wherein the local cache stores a first valid duration corresponding to the first service state value, and the service state maintenance module determines whether the first service state value has expired by referring to the timer and the first valid duration.

21. The apparatus as claimed in claim 20 wherein the timer is an absolute timer whose value is increased by one every clock interval, the local cache stores a first time value indicating an instant when storing the first service state value, and the service state maintenance module determines that the first service state value has expired when the difference between a second time value counted by the absolute timer and the first time value exceeds or equals a value corresponding to the first valid duration.

22. The apparatus as claimed in claim 20 wherein the timer is a programmable timer whose value is decreased by one every time unit, the service state maintenance module initiates the value of the programmable timer to correspond to the first valid duration when storing the first service state value, and the service state maintenance module determines that the first service state value has expired when the value of the programmable timer is equal to or lower than “0”.
